(19) United States
(12) Patent Application Publication
(10) Pub. No.: US 2026/0363492 A1
(43) Pub. Date: Nov. 19, 2026

(54) Anti-detachment composite cutting board

(71) Applicant: Jieyang Fengxing Stainless Steel Products Co., Ltd., Jieyang (CN)

(72) Inventors: Shenqian Lin, Jieyang (CN); Jinlong Zheng, Jieyang (CN)

(21) Appl. No.: 19/731,321

(22) Filed: Jul. 6, 2026

(30) Foreign Application Priority Data
May 15, 2026 (CN) 202620693300.0

(51) Int. Cl. A47J 47/00

(52) U.S. Cl. CPC A47J 47/005

(57) ABSTRACT

An anti-detachment composite cutting board is provided to solve the technical problems that a metal panel of the existing composite cutting board is easily detached and dirt is easily accumulated along edges. The cutting board includes a plastic board body and a metal panel. A flange with a lap-joint ring is arranged at an edge of the metal panel, and the flange and/or the lap-joint ring is embedded inside the plastic board body and are injection-molded. An embedded rib with a through hole is fixed on a bottom surface of the metal panel, and the plastic fills the through hole during injection molding to form a serially connected structure.

### TECHNICAL FIELD

The present disclosure relates to the technical field of kitchen utensils, and in particular, to an anti-detachment composite cutting board.

### BACKGROUND

A cutting board is an indispensable kitchen tool in daily life. Traditional wooden or bamboo cutting boards are prone to mold growth and shredding, and are difficultly cleaned. Fully plastic cutting boards are easily scratched, get dirty during use, and have poor high-temperature resistance performance.

To address the aforementioned issues, composite cutting boards prepared from metal and plastic have emerged in the existing technology. Typically, a plastic layer is injection-molded onto a metal plate, or a metal panel is laminated onto a plastic base plate. However, the existing composite cutting board has the following drawbacks: poor bonding strength: a difference in thermal expansion coefficients of the metal and the plastic is relatively large, so that the metal panel is easily peeled off from a plastic base, upwarped, or detached when subjected to temperature fluctuations or cut; improper edge treatment: exposed metal edges or simple coverings easily injure hands, and moisture and food residues easily permeate into the bonding gaps, thus causing bacterial growth; monolithic structure: most cutting boards are of a single-layer metal structure, so that they cannot simultaneously meet a safety requirement for food-contact surfaces (e.g., antibacterial property) and a requirement for overall structural supporting strength. Therefore, there is an urgent need for a novel composite cutting board that has a stable structure, an anti-detachment property, and safety of use.

### SUMMARY

An objective of the present disclosure is to provide an anti-detachment composite cutting board, to solve the problems that a metal panel and a plastic base are not firmly combined and are easily detached and easily bulges, and dirt is easily accumulated along edges.

In order to achieve the above objective, the present disclosure provides the following technical solutions:

An anti-detachment composite cutting board includes a plastic board body and a metal panel located on an upper side of the plastic board body.

A flange bending towards the plastic board body is arranged at an edge of the metal panel. A bottom of the flange is folded inwards to form a lap-joint ring. The lap-joint ring is embedded inside the plastic board body and is combined with the plastic board body by injection molding.

At least one embedded rib is fixed on a surface of the metal panel facing the plastic board body, and the embedded rib is embedded into the plastic board body to prevent the metal panel from deforming and moving.

At least one penetrating through hole is formed in the embedded rib, and a plastic material of the plastic board body fills and is solidified within the through hole, to serially connect and fix the embedded rib to the plastic board body, to prevent the metal panel from deforming and bulging.

In a further optimization of the present disclosure:
the embedded rib is distributed in a strip, mesh, or ring pattern.

The flange is wrapped around an outer side surface of the plastic board body, to form a metal edge wrapping structure. Or, the flange is embedded into the plastic board body, and both an inner wall and an outer wall of the flange are combined with the plastic board body through injection molding.

A plastic handle is integrally injection-molded on one side of the plastic board body.

The present disclosure further provides another technical solution: An anti-detachment composite cutting board includes a plastic board body and a composite metal panel.

The composite metal panel includes an upper-layer metal panel located on an upper side of the plastic board body and a lower-layer metal panel located on a lower side of the plastic board body.

Flanges bending towards the plastic board body are arranged at an edge of the upper-layer metal panel and an edge of the lower-layer metal panel. Bottoms of the flanges are folded inwards to form lap-joint rings. The lap-joint rings are embedded inside the plastic board body and are combined with the plastic board body by injection molding.

At least one embedded rib is fixed on a surface, facing the plastic board body, of the upper-layer metal panel and/or the lower-layer metal panel, and the embedded rib is embedded into the plastic board body.

At least one penetrating through hole is formed in the embedded rib, and a plastic material of the plastic board body fills and is solidified within the through hole, to serially connect and fix the embedded rib to the plastic board body.

Further, the upper-layer metal panel is a titanium or titanium alloy panel for being in contact with food, and the lower-layer metal panel is a stainless steel panel for supporting.

The cutting board further includes a metal handle. The metal handle is welded and fixed to outer walls of the flanges. Or the metal handle is pre-buried in the plastic board body and combined with the plastic board body through injection molding.

Beneficial effects of the present disclosure are as follows: Multiple anchoring structures: through a quadruple structure of flange+lap-joint ring+embedded rib+through hole, plastic flows into the through hole during injection molding to form a plastic rivet, to lock the metal panel inside the plastic panel body like stringing tanghulu, thus completely solving the problem of detachment caused by thermal expansion and contraction; fully enclosed wrapping: the design of the flange and the lap-joint ring not only enhances the bonding force, but also closes metal edges, to prevent dirt accumulation, so that the cutting board has a mellow rounded hand feel and will not injure hand; functional zone optimization: due to the double-sided metal design, one side is made of a titanium material with good biocompatibility to cut cooked food or vegetables, and the other side is made of high-strength stainless steel to cut raw meat or bones, thus balancing health and durability.

The present disclosure will be further described in detail below in conjunction with the embodiments and the accompanying drawings.

### BRIEF DESCRIPTION OF THE DRAWINGS

FIG. 1 is a schematic diagram of a three-dimensional structure according to a first embodiment of the present disclosure;

FIG. 2 is a schematic diagram of a partially split three-dimensional structure according to an embodiment of FIG. 1;

FIG. 3 is a schematic diagram of a split three-dimensional structure according to an embodiment of FIG. 1;

FIG. 4 is a schematic diagram of a three-dimensional structure according to a second embodiment of the present disclosure;

FIG. 5 is a schematic diagram of a partially split three-dimensional structure according to an embodiment of FIG. 4;

FIG. 6 is a schematic diagram of a split three-dimensional structure according to an embodiment of FIG. 4;

FIG. 7 is a schematic diagram of a three-dimensional structure according to a third embodiment of the present disclosure; and

FIG. 8 is a schematic diagram of a split three-dimensional structure according to an embodiment of FIG. 7.

### IN THE DRAWINGS

1: plastic board body; 2: metal panel; 21: flange; 22: lap-joint ring; 23: embedded rib; 231: through hole; 3: plastic handle; 4: metal handle; 2a: upper-layer metal panel; and 2b: lower-layer metal panel.

### DETAILED DESCRIPTION OF THE EMBODIMENTS

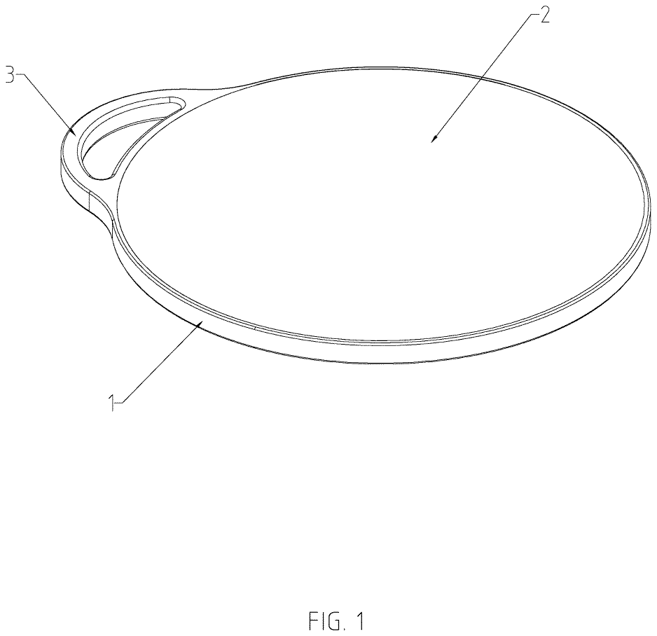

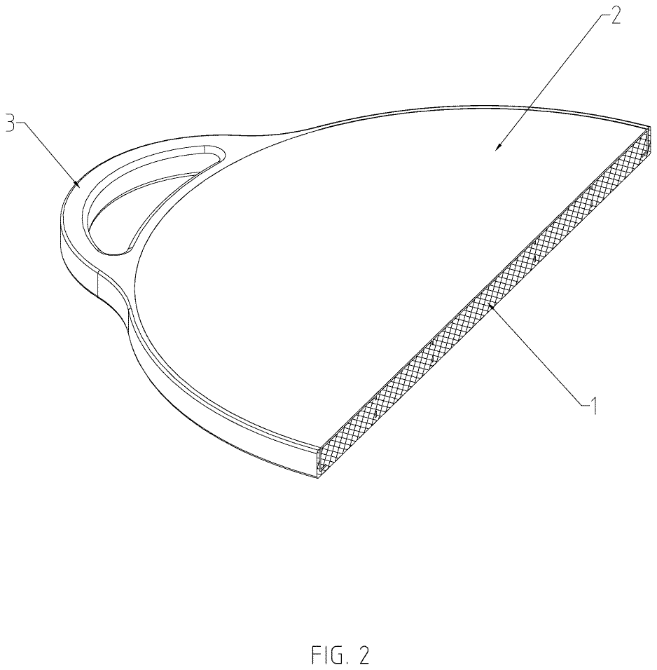

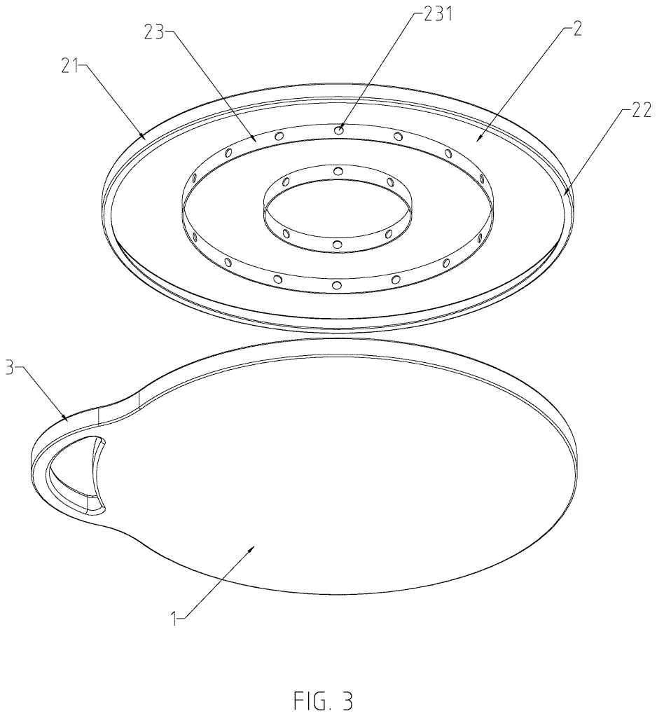

Referring to FIG. 1 to FIG. 3, this embodiment 1 provides a circular single-sided metal anti-detachment cutting board. A main body is a plastic board body 1. The upper surface of the plastic board body is combined with a metal panel 2. The metal panel is preferably made of a 304 stainless steel or titanium alloy plate. An edge of the metal panel 2 bends downwards to form a flange 21. A bottom end of the flange 21 horizontally bends inwards to form a lap-joint ring 22. In an injection molding process, molten plastic wraps around the flange 21 and the lap-joint ring 22. After cooling, the flange 21 and the lap-joint ring 22 are completely locked inside the plastic board body 1, to form a first anti-detachment line.

An embedded rib 23 is fixed on a lower surface (namely a surface facing plastic) of the metal panel 2 through a spot welding technology. The embedded rib 23 is designed as a ring, or can be strip-shaped or grid-shaped. A plurality of through holes 231 are formed in the embedded rib 23. During injection molding, liquid plastic fills the through holes 231 and forms plastic columns after being solidified. The metal embedded rib 23 is connected in series with the plastic panel body 1 to form a second anti-detachment line, to prevent the metal panel from deforming and bulging.

In addition, one side of the plastic board body 1 is integrally injection-molded with a plastic handle 3, which is easily gripped and provides heat insulation and scalding resistance.

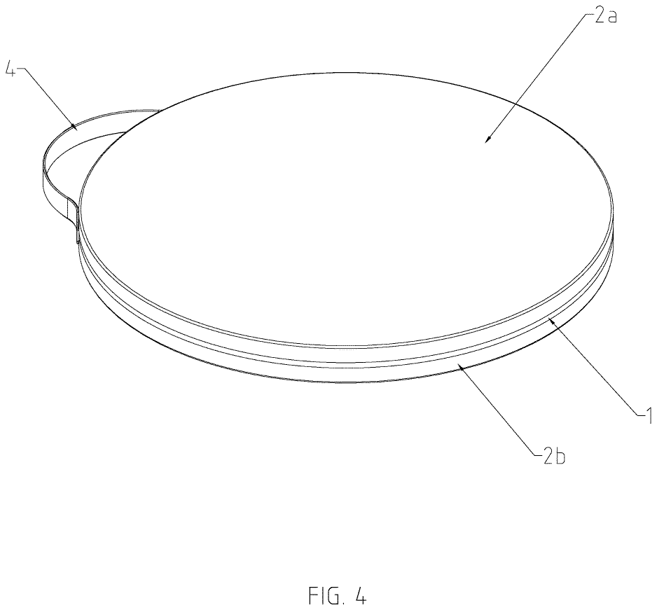

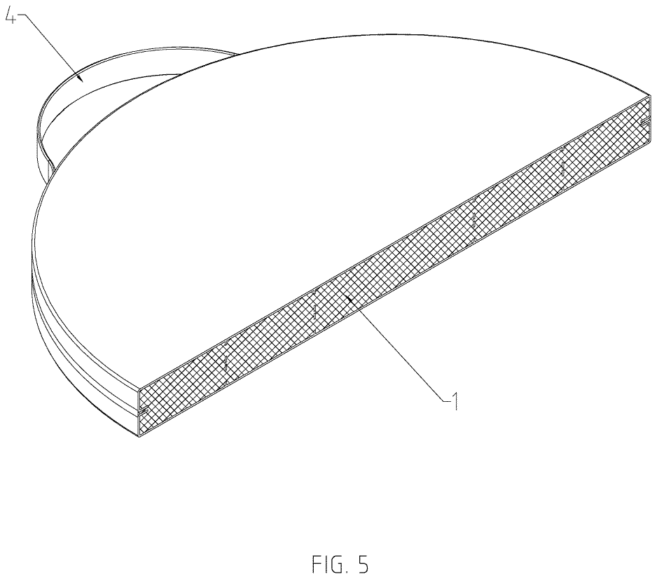

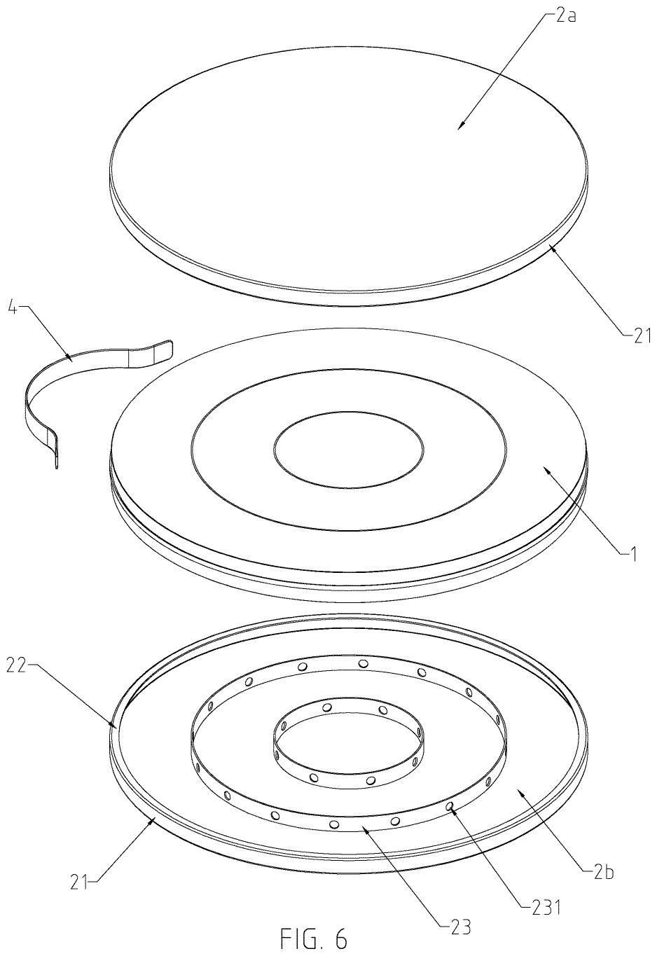

Referring to FIG. 4 to FIG. 6, this embodiment 2 provides a circular double-sided composite metal anti-detachment cutting board. This embodiment provides a double-sided anti-detachment composite cutting board, including a plastic board body 1, an upper-layer metal panel 2a located on an upper side of the plastic board body 1, and a lower-layer metal panel 2b located on a lower side of the plastic board body 1. The upper-layer metal panel 2a is made of a titanium or titanium alloy material because this material has excellent biocompatibility and antibacterial property, and is suitable for being in direct contact with cooked food and fruits. The lower-layer metal panel 2b is made of 430 or 304 stainless steel to provide high supporting force, and is suitable for chopping bones.

The upper and lower-layer metal panels are both provided with flanges 21 and lap-joint rings 22, and are fixed in series with the plastic panel body 1 through the embedded rib 23 to prevent the metal panels from deforming and bulging.

In this embodiment, the flanges 21 of the upper and lower-layer metal panels are both wrapped around an outer side surface of the plastic panel body 1, thus forming a complete metal wrapping edge that is attractive and wear-resistant. A metal handle 4 is arranged on a side edge. The metal handle 4 is directly welded to the flanges 21.

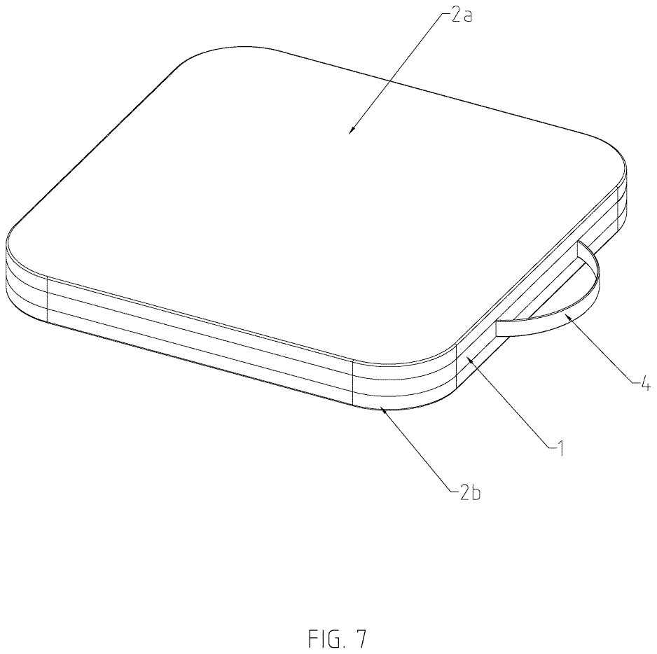

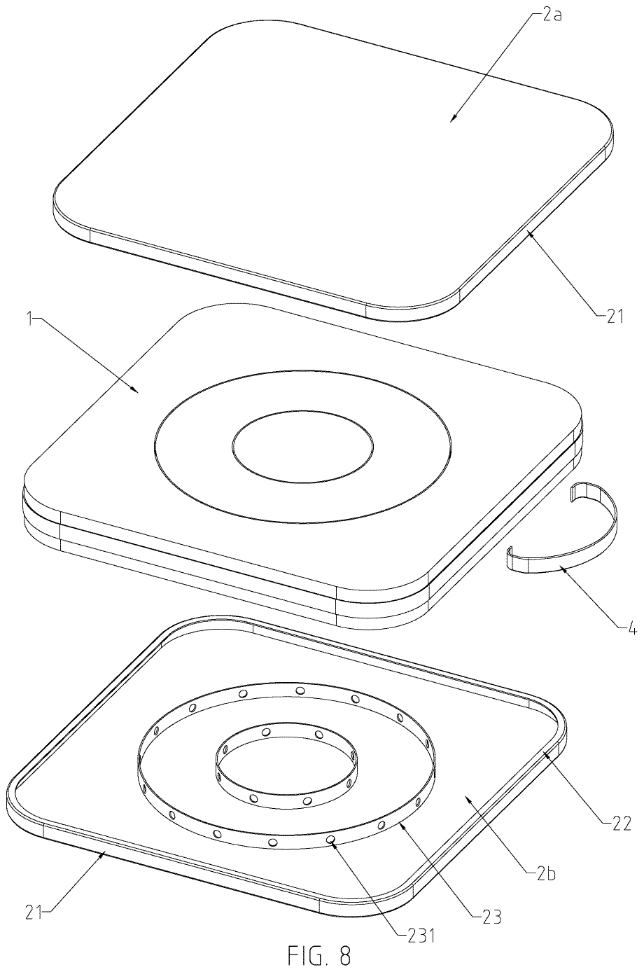

Referring to FIG. 7 to FIG. 8, this embodiment 3 is a square double-sided composite metal anti-detachment cutting board. This embodiment also provides a double-sided anti-detachment composite cutting board. A difference from Embodiment 2 is that the metal handle 4 is pre-buried in a mold before injection molding and is injected into an integrated structure with the plastic board body 1.

The above description is only an implementation example of the present disclosure and is not intended to limit the present disclosure. Any modification, equivalent replacement, and improvement made within the spirit and scope of the present disclosure shall fall within the protection scope of the present disclosure.

What is claimed is:

1. An anti-detachment composite cutting board, comprising a plastic board body (1) and a metal panel (2) located on an upper side of the plastic board body (1), wherein
a flange (21) bending towards the plastic board body is arranged at an edge of the metal panel (2); a bottom of the flange (21) is folded inwards to form a lap-joint ring (22); the lap-joint ring (22) is embedded inside the plastic board body (1) and is combined with the plastic board body (1) by injection molding;
at least one embedded rib (23) is fixed on a surface of the metal panel (2) facing the plastic board body (1), and the embedded rib (23) is embedded into the plastic board body (1); and
at least one penetrating through hole (231) is formed in the embedded rib (23), and a plastic material of the plastic board body (1) fills and is solidified within the through hole (231), to serially connect and fix the embedded rib (23) to the plastic board body (1).

2. The anti-detachment composite cutting board according to claim 1, wherein the embedded rib (23) is distributed in a strip, mesh, or ring pattern.

3. The anti-detachment composite cutting board according to claim 1, wherein the flange (21) is wrapped around an outer side surface of the plastic board body (1), to form a metal edge wrapping structure.

4. The anti-detachment composite cutting board according to claim 1, wherein the flange (21) is embedded into the plastic board body (1), and both an inner wall and an outer wall of the flange (21) are combined with the plastic board body (1) through injection molding.

5. The anti-detachment composite cutting board according to claim 1, wherein a plastic handle (3) is integrally injection-molded on one side of the plastic board body (1).

6. An anti-detachment composite cutting board, comprising a plastic board body (1) and a composite metal panel, wherein
the composite metal panel comprises an upper-layer metal panel (2a) located on an upper side of the plastic board body (1) and a lower-layer metal panel (2b) located on a lower side of the plastic board body (1);
flanges (21) bending towards the plastic board body are arranged at an edge of the upper-layer metal panel (2a) and an edge of the lower-layer metal panel (2b); bottoms of the flanges (21) are folded inwards to form lap-joint rings (22); the lap-joint rings (22) are embedded inside the plastic board body (1) and are combined with the plastic board body (1) by injection molding;
at least one embedded rib (23) is fixed on a surface, facing the plastic board body (1), of the upper-layer metal panel (2a) and/or the lower-layer metal panel (2b), and the embedded rib (23) is embedded into the plastic board body (1); and
at least one penetrating through hole (231) is formed in the embedded rib (23), and a plastic material of the plastic board body (1) fills and is solidified within the through hole (231) to serially connect and fix the embedded rib (23) to the plastic board body (1).

7. The anti-detachment composite cutting board according to claim 6, wherein the embedded rib (23) is distributed in a strip, mesh, or ring pattern.

8. The anti-detachment composite cutting board according to claim 6, wherein the flanges (21) are wrapped around an outer side surface of the plastic board body (1), to form a metal edge wrapping structure.

9. The anti-detachment composite cutting board according to claim 8, further comprising a metal handle (4), wherein the metal handle (4) is welded and fixed to outer walls of the flanges (21); or the metal handle (4) is pre-buried in the plastic board body (1) and combined with the plastic board body (1) through injection molding.

10. The anti-detachment composite cutting board according to claim 6, wherein the upper-layer metal panel (2a) is a titanium or titanium alloy panel for being in contact with food, and the lower-layer metal panel (2b) is a stainless steel panel for supporting.
